(19) United States
(12) Patent Application Publication
(10) Pub. No.: US 2022/0018180 A1
(43) Pub. Date: Jan. 20, 2022

(54) MULTI-SEGMENT RETRACTABLE CURTAIN WITH UNIVERSAL CONNECTOR

(71) Applicants: Andrew C. LAMBRIDIS, Dix Hills, NY (US); Ashraf GOMAA, Stony Brook, NY (US); Oscar ESCOBAR, Glendale, NY (US)

(72) Inventors: Andrew C. LAMBRIDIS, Dix Hills, NY (US); Ashraf GOMAA, Stony Brook, NY (US); Oscar ESCOBAR, Glendale, NY (US)

(21) Appl. No.: 17/377,070

(22) Filed: Jul. 15, 2021

Related U.S. Application Data
(60) Provisional application No. 63/053,391, filed on Jul. 17, 2020.

(51) Int. Cl. E06B 9/17; E06B 9/70

(52) U.S. Cl. CPC E06B 9/17; E06B 9/70

(57) ABSTRACT

A multi-curtain assembly has curtain segments of a retractable curtain, the curtain segments having leading edges affixed to a bottom bar and extending between opened and closed positions by winding on and unwinding from a barrel assembly, each curtain segment being optionally connectable to the other curtain segment adjacent thereto by a fastener at respective adjacent edges of each curtain segment during unwinding. The multi-curtain assembly includes: a motor driving the barrel assembly of a first curtain segment, adjacent and further curtain segments meeting one another at an interface angle; and at least one curtain driving interface that passes along a rotational barrel driving force from the barrel assembly of the first one of the plurality of curtain segments. The driving interface being an interface for angle of 90 degrees, of less than 90 degrees, or greater than 90 degrees, or an interface for barrel assemblies at different heights.

### CROSS-REFERENCE TO RELATED APPLICATION

This application claims benefit under 35 U.S.C. 119(e) of U.S. Provisional Patent Application No. 63/053,391, filed Jul. 17, 2020, the entirety of which is incorporated by reference herein.

### BACKGROUND OF THE INVENTION

### 1. Field of the Invention

The present invention relates to retractable smoke/fire curtains having multiple sections or segments so that a curtain assembly can be formed with the multiple segments to extend between irregular shaped openings. In particular, the invention pertains to an assembly having multiple-arranged retractable curtain segments and which, optionally, employs strips of curtain fabric at interfaces of the multiple curtain segments arranged across such irregular openings.

### 2. Discussion of Related Art

Existing rolling curtain assemblies may employ multiple adjacent segments of curtain, either due to a large width of an opening required to be covered, or because of a change in curtain segment orientations, such as an opening in a corner of room. It is known to have structure providing an automatic connection between two curtain edges using a zipper or other fastening mechanism, e.g., hook/loop fastener or magnets. Such systems automatically attach opposing curtain segment edges upon deployment of the curtain segments from a retracted state to an extended state, and automatically separate the segment edges when the segments are moved back to their retracted states, namely as they deploy to/from a take-up roller.

In the context of fire or smoke curtains, an extra concern is that when such connections are used to connect adjacent curtain segments, fire and/or smoke, e.g., during a fire condition, can seep through connection seams, such as through the zippered or releasably attached interface of adjacent curtain segments.

A further concern is in the attachment of the multiple curtain segments such that they can extend or retract in a synchronous manner, usually with the use of a separate motor operator for each curtain segment, with the operators being synchronously controlled to turn at the same rate. Current curtain segment interfaces are limited in the angular range that can be accommodated. Thus, while curtain segments arranged at 90 degrees can be managed, orientations greater than 90 degrees become more problematic and present system failure, particularly at the curtain segment interfaces.

There is, therefore, a need for a retractable curtain arrangement having multiple curtain segments with improved range of orientation.

### SUMMARY OF THE INVENTION

The terms “fire curtain”, “smoke curtain”; and “fire/smoke curtain” are used interchangeably to reference a curtain having fire and/or smoke blocking capabilities.

In accordance with a first aspect of the invention, a multi-curtain assembly has a plurality of curtain segments of a retractable curtain, positioned in a structure, the curtain segments having leading edges affixed to a bottom bar and configured to extend between opened and closed positions by winding on and unwinding from a barrel assembly, each curtain segment being optionally connectable to the other curtain segment adjacent thereto by a fastener at respective adjacent edges of each curtain segment during unwinding. The multi-curtain assembly includes: a motor driving the barrel assembly of a first one of the plurality of curtain segments, adjacent and further ones of the plurality of curtain segments meeting one another at an interface angle; and at least one curtain driving interface configured to pass along a rotational barrel driving force from the barrel assembly of the first one of the plurality of curtain segments. The driving interface is one selected from the group consisting of: (a) an interface for an interface angle of 90 degrees; (b) an interface for an interface angle of less than 90 degrees; (c) an interface for an interface angle of greater than 90 degrees; and (d) an interface where one barrel assembly is at a height that is different from another barrel assembly.

In another aspect, the multi-curtain assembly further includes: an overlay strip having a leading edge proximate a leading edge of at least one of the plurality of curtain segments and a curtain segment adjacent thereto; and a retractable overlay collector roller attached to a first end of the overlay strip and configured to allow the overlay strip to wind on and unwind from a collector roller synchronously with the winding and unwinding of the at least one and the adjacent curtain segments with respect to the barrel assembly, the retractable fastener overlay strip being arranged, in its extended position, in front of or behind the fastener that connects the adjacent curtain segments.

In another aspect, in a case of group (c), the interface is a universal interface.

In another aspect, in a case of group (a) or (b), the interface is a bevel gear interface.

In another aspect, the leading edge of the overlay strip is attached to the bottom bar.

In another aspect, the overlay strip has a width that is wider than a width of the fastener or a space between adjacent curtain edges.

In another aspect, the barrel assembly includes a first barrel assembly for deploying the first curtain segment and a second barrel assembly for deploying the second curtain segment.

In another aspect, the first and second barrel assemblies are deployed synchronously with each other.

In another aspect, the multi-curtain assembly further comprising a holder mounted to the structure and to which the retractable overlay roller is rotatably mounted to rotate with respect to the holder.

In another aspect, the holder is positioned in alignment with the fastener.

In another aspect, in the case of group (a), in the case in which adjacent curtain segments are positioned at heights different from one another, the interface includes a bevel gearing and a sprocket and chain gearing.

In another aspect of the invention, a curtain assembly is arranged at an interface between a first curtain segment and an adjacent second curtain segment of a retractable curtain, positioned at an interface of the adjacent curtain segments.

The curtain segments are composed smoke and/or fire retardant material and have leading edges affixed to a bottom bar and configured to extend between opened and closed positions by winding unwinding on a barrel assembly. Each curtain segment may be optionally connectable to another curtain segment adjacent thereto by a fastener at respective adjacent edges of each curtain segment during unwinding. One or more overlay assemblies may be provided, each having an overlay strip having a leading edge proximate a leading edge of at least one of the plural curtain segments; and a retractable overlay collector roller attached to a first end of the overlay strip and configured to allow the overlay strip to wind on and unwind from a collector roller synchronously with the winding and unwinding of all of the curtain segments with respect to the barrel assembly. If a retractable fastener overlay strip is used, it is arranged, in its extended position, in front of or behind the adjacent edges of the curtain segments, irrespective of whether those edges are attached to each other, such as by a zipper.

In yet another aspect, the leading edge of the overlay strip is also attached to the bottom bar so that movement of the bottom bar extends the overlay strip from the collector roller.

In yet another aspect, the barrel assembly comprises a plurality of barrel assemblies for deploying the respective curtain segments.

In yet another aspect, a designated barrel assembly is provided for each curtain segment, and the barrel assemblies are deployed synchronously with each other.

In yet another aspect, the fastener overlay assembly has a holder mounted to the structure and to which the retractable overlay roller is rotatably mounted to rotate with respect to the holder.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The figures are described as follows:

FIG. 1 is an isometric view of a retractable overlay assembly that deploys a strip that functions as a fastener overlay arranged at an interface between two curtains;

FIG. 2 is a magnified view of an area A of FIG. 1;

FIG. 3 is a schematic isometric view of the retractable overlay assembly with the strip that functions as a fastener overlay being illustrated to show the fastener behind the strip;

FIG. 4 is a schematic rear elevation view of the retractable overlay assembly deployed at the interface between two curtains, showing the automatic fastener;

FIG. 5 is a plan view of the retractable overlay assembly deployed at the interface between two curtains;

FIG. 6 is a rear view of the retractable overlay assembly, showing the automatic fastener;

FIG. 7 is a plan view showing a curtain assembly having four curtains, arranged at various interface angles;

FIG. 8 is a front elevation view showing an interface between a first curtain and an adjacent second curtain;

FIG. 9A is a diagram illustrating a universal gearing for an interface between two adjacent curtains oriented at an interface angle greater than 90 degrees;

FIG. 9B is a magnified view of the universal gearing of FIG. 9A;

FIG. 10A is a diagram illustrating an input/output gearing for an interface between two curtains having an interface angle less than 90 degrees;

FIG. 10B is a magnified view of the input/output gearing of FIG. 10A;

FIG. 11 is a diagram illustrating a gearing for an interface between two curtains having an interface angle of 90 degrees;

FIG. 12 is a diagram illustrating the use of bevel gearing for an interface between two curtains having a 90 degree interface angle; and

FIG. 13 is a diagram illustrating the combination of bevel gears and sprocket and chain gearing for interfacing two curtain segments at different heights.

### DETAILED DESCRIPTION OF THE PRESENTLY PREFERRED EMBODIMENTS

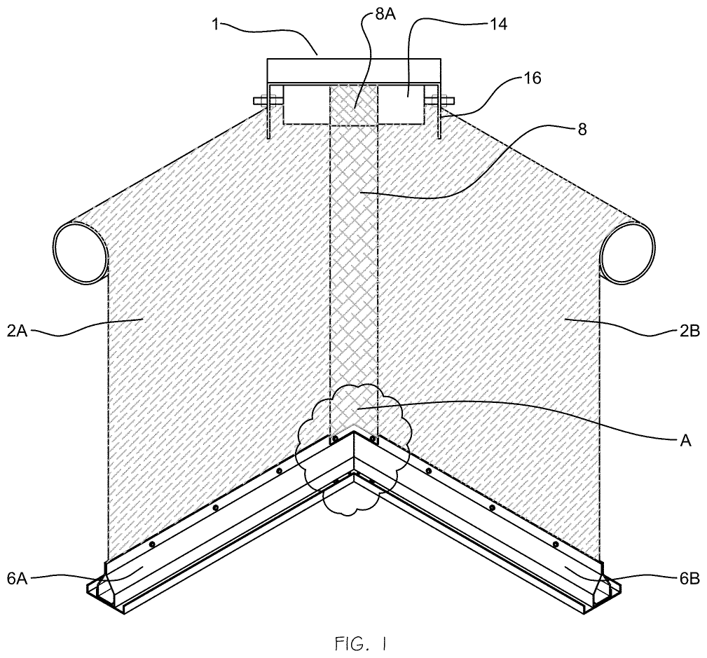

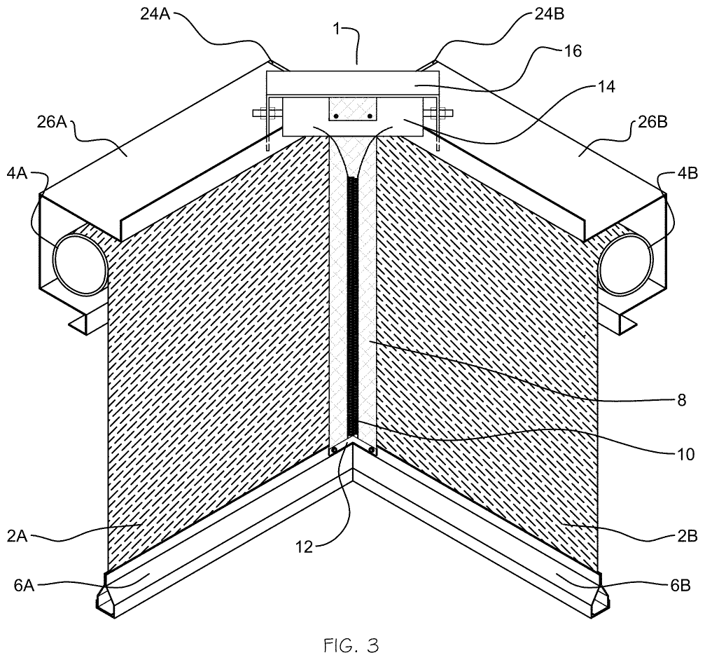

FIGS. 1-6 show various views of a retractable fastener overlay assembly 1 that is arranged at an interface between a first curtain segment 2A and a second curtain segment 2B and that includes a retractable fastener overlay strip 8 of material arranged, in its extended position, in front of adjacent edges of adjacent curtain segments, which may or may not be fastened to each other. As shown, for example, in FIGS. 3, 4 and 6, however, a fastener 10 is provided that connects adjacent edges of the first and second curtain segments 2A and 2B. The curtain segments are made of fire retardant material and/or smoke blocking material, or of textile fabric coated with a fire and/or smoke retardant or smoke blocking material, as is known by those of ordinary skill in the art.

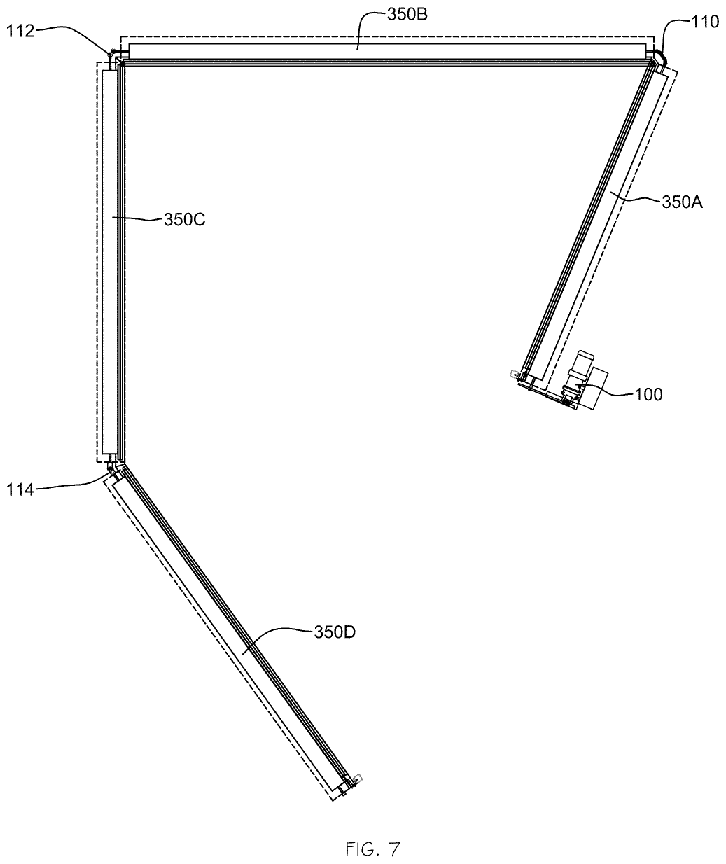

The exemplary illustrated interface in FIGS. 1-6 is deployed at a corner interface of two curtains, also referred to herein as curtain segments. It should be noted that the retractable fastener overlay assembly 1 is not limited to use at a corner interface in a curtain system having only two segments, nor is it limited to 90 degree interface angles. The retractable fastener overlay assembly 1 can also be utilized at an interface that is flat (180 degrees), or at any interface between curtain segments, whatever the interface angle. Moreover, as will be developed below, in particular regard to FIGS. 7-12, the retractable fastener overlay assembly is applicable to multi-curtain assemblies, which can be arranged using differing interface angles allowing coverage of differently shaped wall openings or spaces.

As can be seen in the views of FIGS. 3-5, curtain segment 2A is windable onto a barrel (or barrel assembly) 4A, and curtain segment 2B is windable onto a barrel assembly 4B. So as to maintain the orientation between the illustrated first and second curtain segments, the two barrel assemblies 4A and 4B are configured and arranged so as to wind and unwind in a synchronous manner, for example, by placement of a synchronous gearing connection between them, or by the universal joint or by other appropriate connectors for non-90° corners, all of which would allow a single motor (not shown) to operate both barrels in synch.

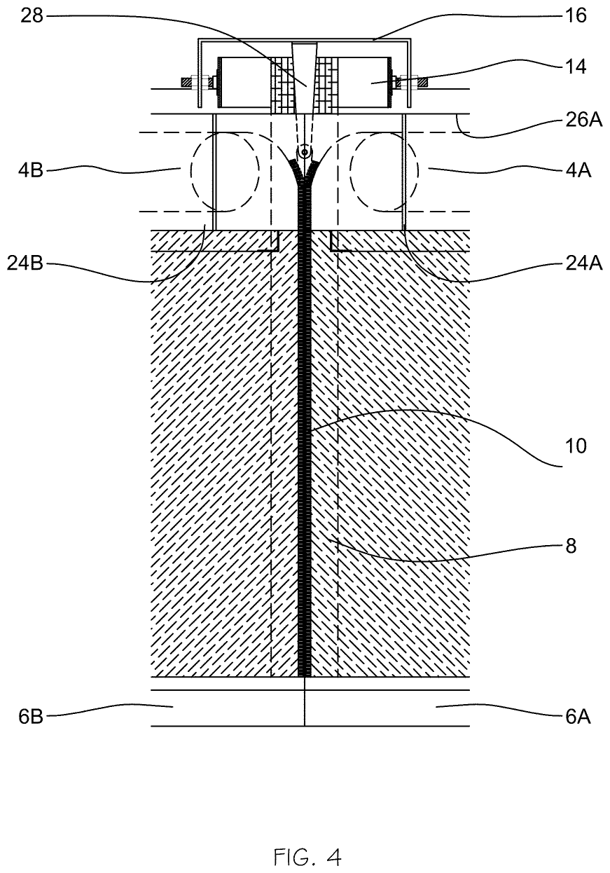

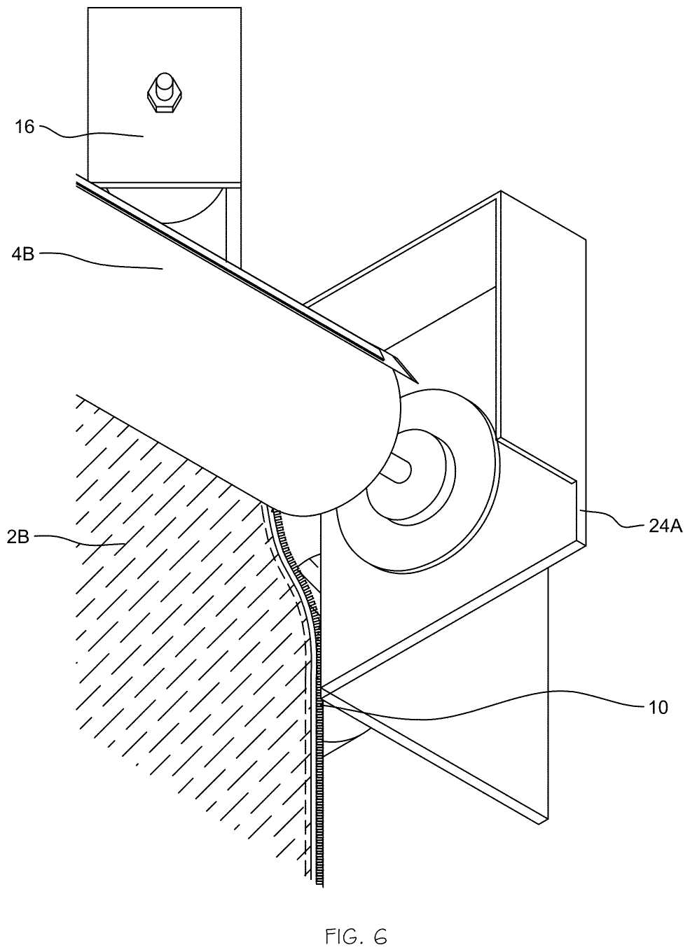

Curtain segments 2A and 2B each have a leading edge fastened to a respective bottom bar 6A, 6B, such as by rivets, screws, or any other suitable manner, whereby, in an extended state, the bottom bars 6A and 6B are positioned on a floor about an opening, as shown in FIG. 1. Also as shown in the illustrated embodiment, the bottom bars are connected to each other at a corner. The curtain segments may optionally be connected to one another along their respective lengths by the fastener 10, for example a zipper, visible in rear views FIGS. 4 and 6, and also visible as a see-through view portion of FIG. 3 to connect adjacent edges of the curtain segments together.

As illustrated in FIG. 3, to securely connect the edges of the two curtain segments 2A, 2B, each of which is windable onto respective barrel assemblies 4A, 4B, the edges at which the curtain segments meet one another are connected by the fastener 10 when the overall curtain is in an extended position. For example, the fastener 10 can be an automatic zipper system that forms a connected zippered seam between edges of the adjacent curtain segments. The automatic zipper system is configured to zip the adjacent edges of the curtain segments together when the two curtain segments are extended, that is, unwound from their respective barrels, to the extended position, namely, as the curtain segments are deployed with respect to an opening. When the curtain segments are retracted or wound back onto their respective barrels, the zippered seam is gradually opened, allowing each of the curtain segments to be completely wound onto its respective barrel assembly.

Other fastening interfaces can, likewise, be deployed by those of ordinary skill in the art such as, for example, hook and loop fasteners where adjacent edges of curtain sections will have a strip of hooks or loops, respectively, or a strip of metal on one interface and a strip of magnetic material on an opposing interface, to provide for attachment and detachment of the curtain segments during deployment/retraction.

The fastener location, i.e., the zipper seam, magnet/metal and/or hook and loop fastener seam, may be prone to seepage wherein smoke from one side of the attached curtain segments will pass through the seam to the other side of the curtain segments. This can result in an unsatisfactory safety condition. To alleviate this concern, a hook/loop arrangement may be positioned on opposing edges of adjacent curtain segments and be made to engage as the zippered edges are closed to cover the zipper “seam”. Alternatively, a retractable fastener overlay assembly 1 may arranged at any interface between curtain segments, for example, the interface between the first curtain segment 2A and the second curtain segment 2B.

As can be seen in FIG. 3, the retractable fastener overlay assembly 1 includes a retractable overlay strip 8 arranged, in its extended position, in front of or behind the fastener 10 that connects the first and second curtain segments 2A and 2B. This is achieved by the fastener overlay strip 8 being itself windable onto a retractable overlay collector barrel 14 positioned proximate the fastener 10 and having a leading edge affixed to one or both of the bottom bars 6A, 6B, as seen in FIG. 3. Thus, as the bottom bars are extended toward the floor of the opening, the overlay strip 8 will be deployed from barrel 14.

The retractable overlay collector barrel 14 is configured to provide an urging force, such as a spring bias, in a direction to urge the overlay strip 8 toward the barrel 14. Such a configuration allows the overlay strip 8 to remain taut so as to closely follow the curtain segments 2A and 2B up and down in a synchronized manner, without the need for a separate motor for the retractable overlay collector barrel 14.

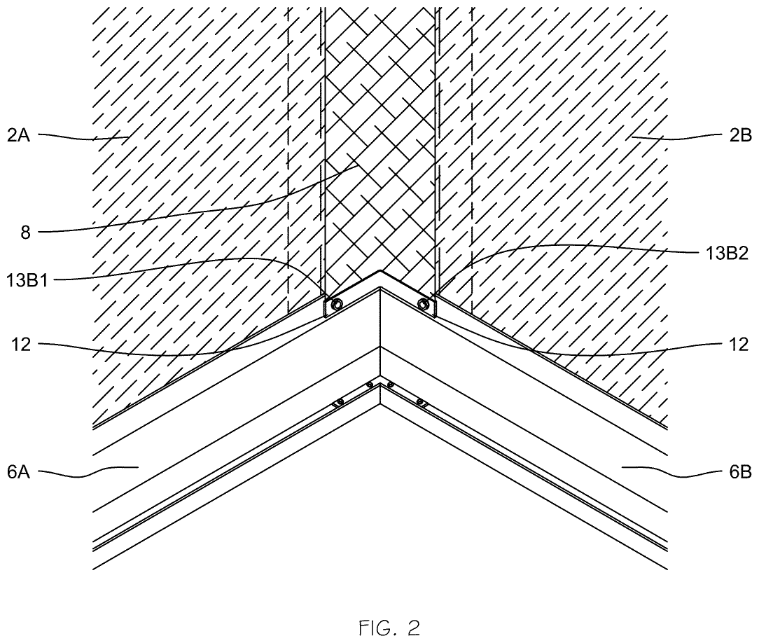

More particularly, the bottom bar assemblies 6A and 6B are affixed to the leading edges of curtain segments 2A and 2B, respectively, and to the bottom of the overlay strip 8. In this manner, even upon a synchronous winding up (i.e., retraction) of the two curtain segments 2A and 2B, the bottom bar assemblies allow the two curtain segments and the overlay strip 8 to maintain their relative positions with respect to one another. As can be seen in FIG. 2, which is a magnified view of area A in FIG. 1, an angled overlay bottom bar connector 12 is attached to the curtain segment bottoms, and to the bottom corners of the overlay strip 8, using bolts 1361 and 1362. The angle of the bottom bar connector is configured to match the interface angle between the curtain segments 2A and 2B.

With reference to FIG. 3, each barrel assembly 4A, 4B is arranged within a respective hood 26A, 26B. Also, the retractable overlay collector (barrel) 14 is arranged within a collector mounting holder 16, and engages side portions of the holder 16, to allow rotation of the overlay collector (barrel) 14 during deployment and retraction of the overlay strip 8.

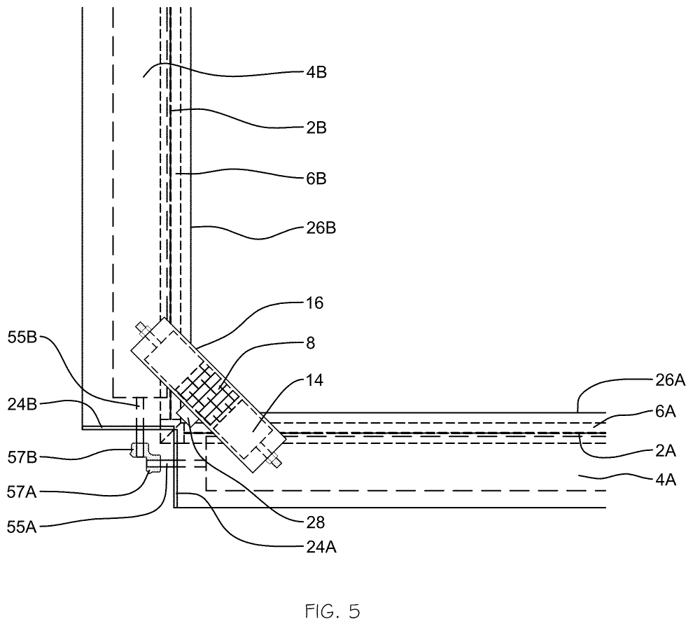

In the illustrated embodiment, for example as seen in FIGS. 4 and 5, the collector mounting holder 16 is affixed to the point at which hoods 26A and 26B meet one another and overlaps portions of both hoods. An automatic fastener holder 28 extends from the top of the collector mounting holder 16 downward vertically to a connection point that is coaxial with the axis of the automatic fastener 10.

Support brackets 24A and 24B are provided to support the barrel assemblies. FIG. 6, for example, shows the support bracket 24A connected to a structure of the building opening across which the assembly is mounted to support the weight of the fire curtain assembly.

As can be seen in FIG. 5, each barrel assembly 4A, 4B has, at one end, a respective barrel shaft 55A, 55B. Each barrel shaft is configured to wind and unwind in a synchronous manner through the use of separate motor operators for each barrel, or by connecting the barrels to each other through gearing or the like such that a single operator motor can be used.

The upward urging force on the overlay strip 8, combined with the fact that the strip 8 is connected fixedly to the bottom bar assemblies 6A and 6B prevent slack from forming between the curtain segments 2A, 2B and the overly strip 8 when the curtain is deployed. Further, the pressure differential between the volume of air in front of the curtain and the air behind the curtain, particularly during a fire condition, maintains a slight bowing frontwardly of each curtain segment, which also provides a force that helps to maintain the contact between the edges of the overlay strip 8 and the curtain segments 2A, 2B.

In practice, the overlay strip 8 snugly positions against the interface of the curtain segments to provide an additional barrier to fire and/or smoke that may be present behind or in front of the fire curtain in the event of a fire or smoke condition.

The above exemplary figures have been shown, for easy illustration, with, for example, the interface angle between the curtain segments 2A and 2B being approximately at a right angle, that is, about 90 degrees. However, it is advantageous to be able to have curtain segments that can be arranged in configurations having different interface angles.

While the invention has been shown, with respect to FIGS. 1-6, for purposes of illustration, in relation to disclosed exemplary embodiments that utilize a two-curtain assembly, the invention is not limited to the embodiments of those figures. For example, although two curtain panels or segments are depicted in FIGS. 1-6, additional curtains can be likewise employed with, or without, additional overlay strips 8 and related assemblies at each interface of adjacent curtain segments.

FIGS. 7-12 illustrate embodiments for adjoining multiple curtains, at various interface angles, to, for example, operate from a single motor. Except as noted below, each instance of a curtain, i.e., curtain segment, and barrel will function and be configured substantially in the manner discussed above. However, the embodiment of FIGS. 7-12 will provide structure for arranging multiple ones of the curtain segments, and do so in a way that provides flexibility in the orientation between and among the curtain segments.

FIG. 7 is a plan view of such a multi-curtain assembly. As can be seen from the figure, the multi-curtain assembly comprises of a first barrel 350A closest to, and directly driven by, a motor/operator 100. As can be seen in FIG. 7, the first barrel 350A, at a first interface angle transition joint 110, engages a second barrel 350B. This particular interface angle in the illustrated example is greater than 90 degrees. Details of this joint will be described below.

At the other end of barrel 350B, a second, in this case 90 degree, interface transition joint 112 is provided so that barrel 350B can engage barrel 350C for driving barrel 350C. Finally, at the end of barrel 350C, a third transition joint 114 engages barrel 350D, at an interface angle less than 90 degrees, to drive barrel 350D. Each barrel 350A, 350B, 350C and 350D is arranged within a respective hood 126A, 126B, 126C and 126D.

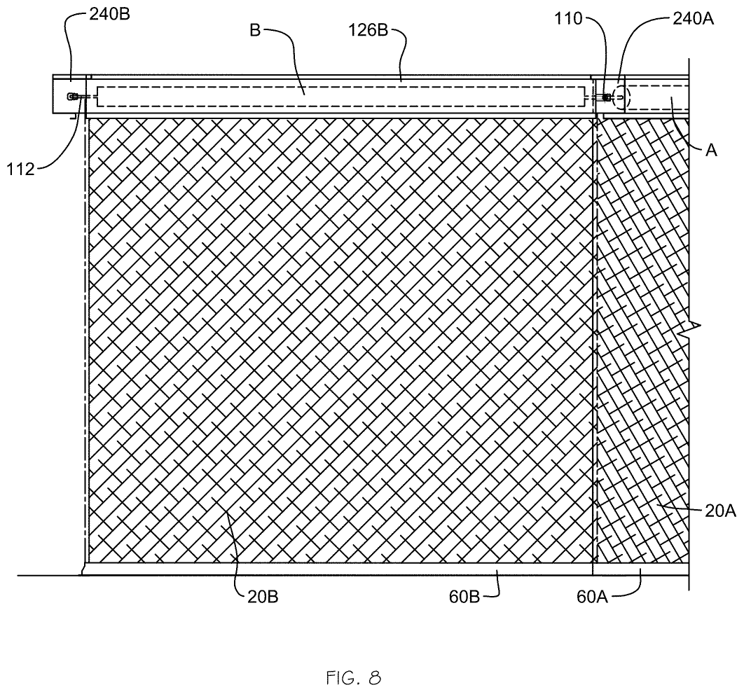

FIG. 8 is a front elevation view showing a transition between two curtains, in this instance, showing the engagement between curtains 20A and 20B, in a multi-curtain assembly. As can be seen in the views of FIGS. 7 and 8, curtain segment 20A is windable onto the barrel 350A, and curtain segment 20B is windable onto the barrel assembly 350B.

To maintain the orientation between curtain segments 20A and 20B, the two barrels (or barrel assemblies) 350A and 350B are configured and arranged so as to wind and unwind in a synchronous manner, for example, by placement of a synchronous gearing connection between them, or universal joint for non-90° corners, which would allow a single motor to operate both barrels and, hence, both curtain segments, or, alternatively, by plural synchronized motors.

Curtain segments 20A and 20B each have a leading edge fastened to a respective bottom bar 60A, 60B, such as by rivets, screws, or any other suitable manner, whereby, in an extended state, the bottom bars 60A and 60B are positioned, together with further bottom bars 60C and 60D (illustrated in further figures), associated with barrels 350C and 350D, respectively, on a floor to enclose a space, as shown in FIG. 7. Also as shown in the illustrated embodiment of FIGS. 1-6, the bottom bars are connected to each other at a corner. The curtain segments may be connected to one another along their respective lengths by the fastener 150, for example a zipper, such as the zipper visible in rear views FIGS. 4 and 6, and also visible as a see-through view portion of FIG. 3, to connect adjacent edges of the curtain segments together.

Although not shown in any detail in FIGS. 7-12, the overlay strip 8 discussed above and illustrated in FIGS. 1-6 can be used, in the manner described above, to snugly position against the interface 150 of the curtain segments to provide an additional barrier to fire and/or smoke that may be present behind or in front of the fire curtain in the event of a fire or smoke condition. However, it is not necessary to use the overlay structure of FIGS. 1-6 in the multi-curtain assembly of FIGS. 7-12.

As shown in FIG. 8, support brackets 240A and 240B are provided to support the barrel assemblies 350A and 350B, respectively. As discussed above, in relation to FIG. 6, for example, each support bracket can be connected to a structure of the building in which the assembly is mounted to support the weight of the fire curtain assembly.

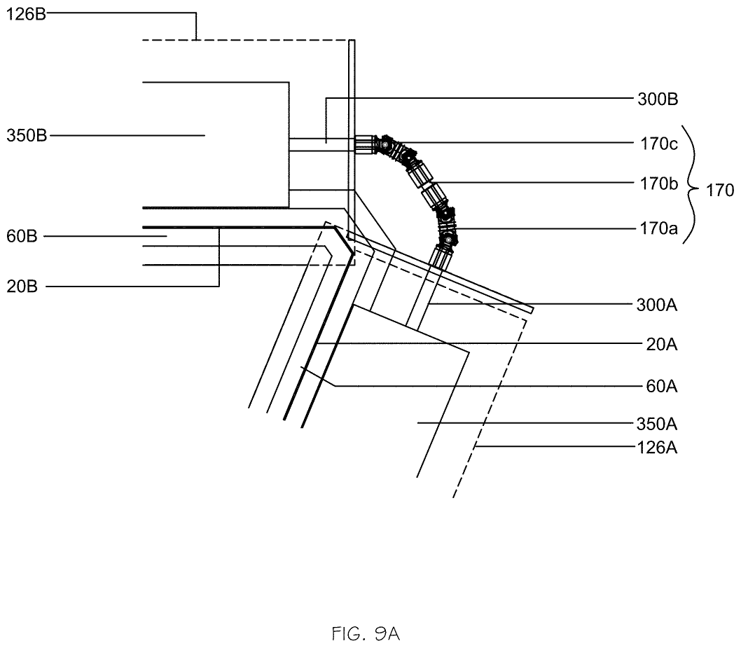

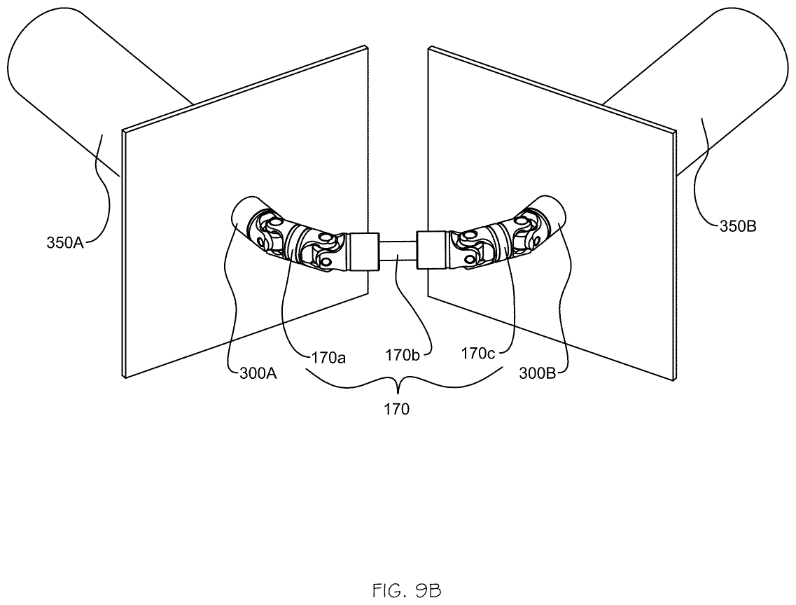

FIGS. 9A and 9B illustrates an interface for an interface angle of greater than 90 degrees. For purposes of illustration, FIGS. 9A and 9B show the interface between barrels 350A and 350B in FIG. 7. In the case of an interface angle of greater than 90 degrees, rather than use two bevel gears as used in a 90 degree interface angle, universal gears 170 is used.

As can be seen in FIGS. 9A and 9B, the universal gearing 170 comprises, in the direction of driving, an output interface gear 170a that is coupled to the output interface shaft 300A of the barrel 350A. The output interface gear 170a is coupled with an intermediate interface shaft 170b, to achieve a partial change in drive orientation.

The intermediate shaft 170b is further coupled to the input interface gear 170c, which achieves a further direction change in drive orientation. After this further direction of drive change is achieved by the input interface gear 170c, the input interface gear 170c is coupled to the input interface shaft 300B of the barrel 350B. Together, the components of the universal gearing 170 effect a change in driving direction, in this case between barrel 350A, connected directly to the motor, and barrel 350B.

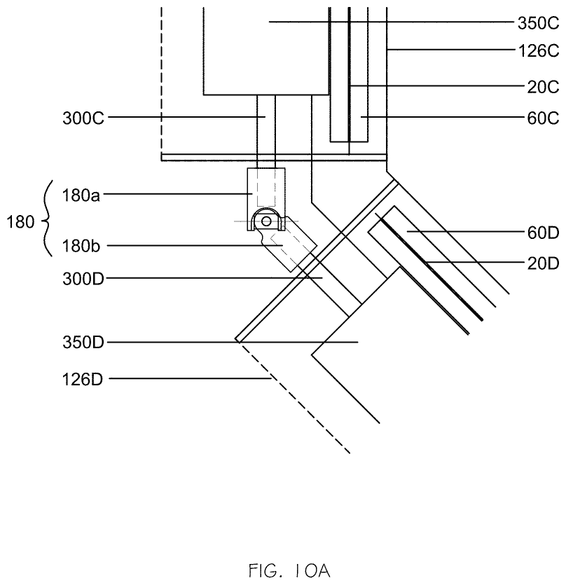

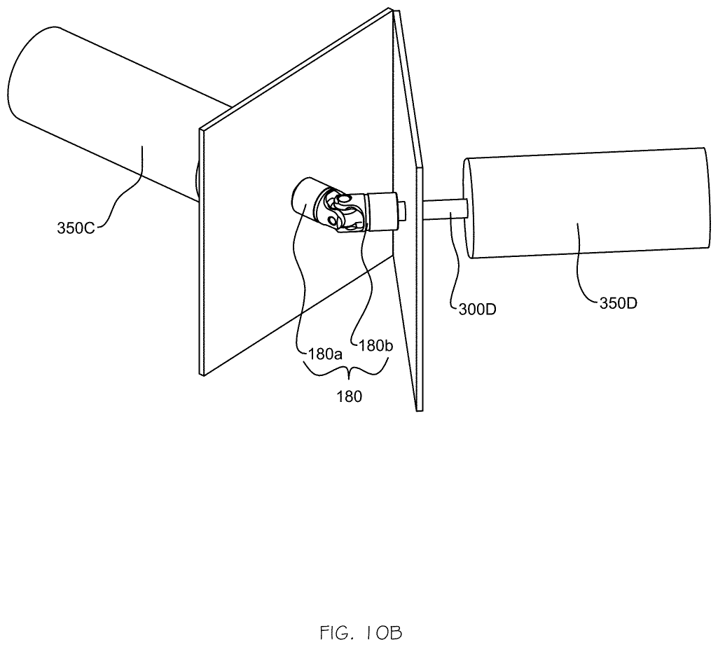

A connection having an interface angle less than 90 degrees is illustrated in FIGS. 10A and 10B. For purposes of illustration, FIGS. 10A and 10B show the interface between barrels 350C and 350D in FIG. 7. In the case of an interface angle of less than 90 degrees, an input/output gearing 180, comprising an output interface gear 180a, and an input interface gear 180b, is used.

The input/output gearing 180 comprises, in a direction of driving, an output interface gear 180a that is coupled to the output interface shaft 300C of the barrel 350C. The output interface gear 180a is coupled with an input interface gear 180b, which is then coupled with an input interface shaft 300D of the barrel 350D, to achieve the change in drive direction of less than 90 degrees of interface angle.

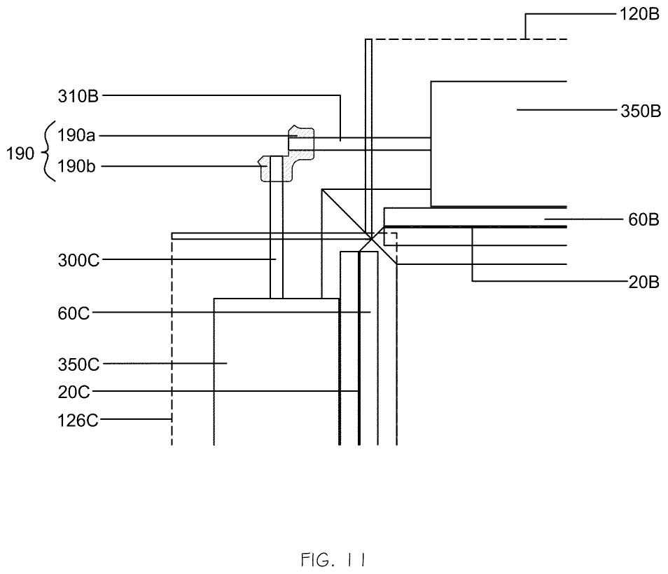

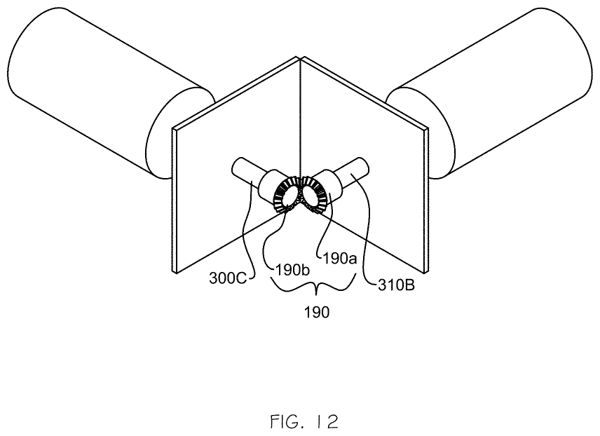

A connection having an interface angle of 90 degrees is illustrated in FIGS. 11 and 12. For purposes of illustration, FIG. 11 shows the interface between barrels 350B and 350C in FIG. 7. In the case of an interface angle of 90 degrees, a gearing 190, comprising an output interface gear 190a, and an input interface gear 190b, is used.

In direction of driving, the gearing 190 comprises an output interface gear 190a that is coupled to the output interface shaft 310B of the barrel 350B. The output interface gear 190a is coupled with an input interface gear 190b, which is then coupled with an input interface shaft 300C of the barrel 350C, to achieve the change in drive direction of 90 degrees of interface angle.

FIG. 12 is a magnified view of one example of gearing 190 in which the output interface gear 190a is a bevel gear coupled with another bevel gear that is the input interface gear 190b.

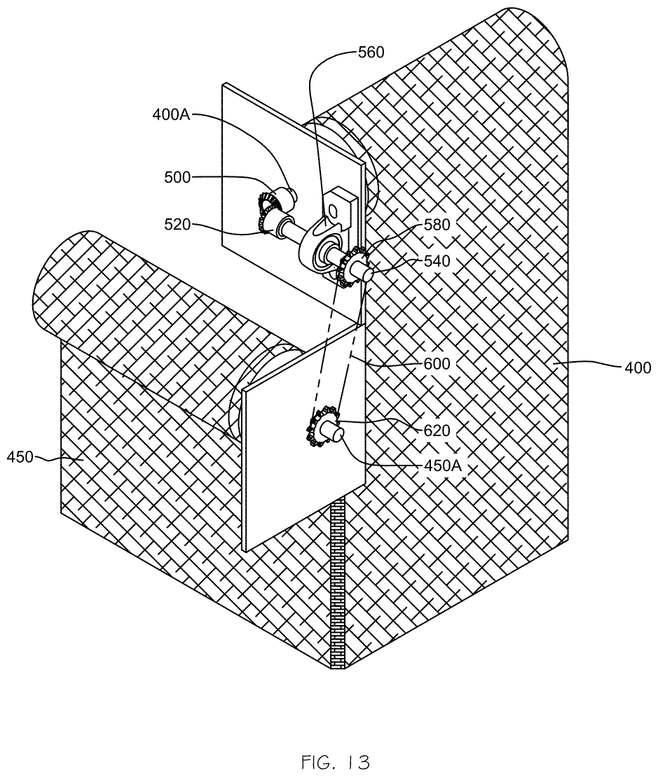

FIG. 13 is a diagram illustrating the combination of bevel gears and sprocket and chain gearing for interfacing two curtain segments at different heights. As shown in FIG. 13, curtain segments 400 and 450 are positioned at different heights. In this situation, the output shaft of the two curtains are coupled using a less direct, and thus more complex, gearing that accounts for the different heights of the rollers of each curtain.

In the figure, curtain 400 is positioned at a height higher than curtain 450. To couple the output shaft 400A of the curtain 400 with the input shaft 450A of the curtain 450 thus utilizes the combined bevel and sprocket and chain gearing mechanism shown in FIG. 13.

The output shaft 400A is initially coupled to a first bevel gear 500, which is coupled, to provide a right angled change of direction of drive, to second bevel gear 520, which in turn drives a lateral driveshaft 540. Preferably, the lateral driveshaft is supported by a bearing 560 that is mounted to the end of the support bracket, shown schematically, of the barrel of the curtain 400. After passing through the bearing 560, the lateral driveshaft 540 has, near its end, a first sprocket gear 580, on which a chain 600 is mounted. The chain 600 is also attached/mounted to a second sprocket gear 620, which drives the input shaft 450A of the curtain 450. With this combination of bevel and sprocket and chain gearing, the drive output shaft 400A can drive the drive input shaft 450A in a synchronous manner, even where the shaft of the two barrels are at different heights.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A multi-curtain assembly having a plurality of curtain segments of a retractable curtain, positioned in a structure, the curtain segments having leading edges affixed to a bottom bar and configured to extend between opened and closed positions by winding on and unwinding from a barrel assembly, each curtain segment being optionally connectable to the other curtain segment adjacent thereto by a fastener at respective adjacent edges of each curtain segment during unwinding, the multi-curtain assembly comprising:
a motor driving the barrel assembly of a first one of said plurality of curtain segments, adjacent and further ones of said plurality of curtain segments meeting one another at an interface angle; and
at least one curtain driving interface configured to pass along a rotational barrel driving force from the barrel assembly of the first one of said plurality of curtain segments;
the driving interface being one selected from the group consisting of:
(a) an interface for an interface angle of 90 degrees;
(b) an interface for an interface angle of less than 90 degrees;
(c) an interface for an interface angle of greater than 90 degrees; and
(d) an interface where one barrel assembly is at a height that is different from another barrel assembly.

2. The multi-curtain assembly of claim 1, further comprising:
an overlay strip having a leading edge proximate a leading edge of at least one of the plurality of curtain segments and a curtain segment adjacent thereto; and
a retractable overlay collector roller attached to a first end of the overlay strip and configured to allow the overlay strip to wind on and unwind from a collector roller synchronously with the winding and unwinding of the at least one and the adjacent curtain segments with respect to the barrel assembly,
wherein the retractable fastener overlay strip is arranged, in its extended position, in front of or behind the fastener that connects the adjacent curtain segments.

3. The multi-curtain assembly of claim 1, wherein in a case of group (c), the interface is a universal interface.

4. The multi-curtain assembly of claim 1, wherein in a case of group (a) or (b), the interface is a bevel gear interface.

5. The multi-curtain assembly of claim 1, wherein the leading edge of the overlay strip is attached to the bottom bar.

6. The multi-curtain assembly of claim 1 wherein the overlay strip has a width that is wider than a width of the fastener or a space between adjacent curtain edges.

7. The multi-curtain assembly of claim 1, wherein the barrel assembly comprises a first barrel assembly for deploying the first curtain segment and a second barrel assembly for deploying the second curtain segment.

8. The multi-curtain assembly of claim 4, wherein the first and second barrel assemblies are deployed synchronously with each other.

9. The multi-curtain assembly of claim 1, further comprising a holder mounted to the structure and to which the retractable overlay roller is rotatably mounted to rotate with respect to the holder.

10. The multi-curtain assembly of claim 9, wherein the holder is positioned in alignment with the fastener.

11. The multi-curtain assembly of claim 1, wherein in the case of group (a), in the case in which adjacent curtain segments are positioned at heights different from one another, the interface includes a bevel gearing and a sprocket and chain gearing.
